(19) United States
(12) Patent Application Publication
(10) Pub. No.: US 2005/0180893 A1
(43) Pub. Date: Aug. 18, 2005

(54) Centerless ground thermal desorption tube and method without frit

(76) Inventor: Robert A. Handly, Houston, TX (US)

Correspondence Address: KENNETH L. NASH, P.O. BOX 680106, HOUSTON, TX, 77268-0106, US

(21) Appl. No.: 10/780,412

(22) Filed: Feb. 17, 2004

(51) Int. Cl. B01L 3/00

(52) U.S. Cl. 422/102; 422/101

(57) ABSTRACT

A centerless ground thermal desorption tube comprises an outer barrel and one or more inner spacers insertably positioned within the outer barrel. A suitable sorbent material is positioned within the outer barrel which may be held in place by friction and/or with glass wool plugs, and/or screens, and/or the inner spacers. In one preferred embodiment one glass inner spacer is fused to one end of a glass outer barrel prior to the glass outer barrel being centerless ground to a high precision. The sorbent and/or any wool plugs and/or screens are inserted into a second opposite end of the outer barrel after the centerless grinding process. A second glass is fused to the second end of the glass outer barrel whereby the glass fusing may change the precise tolerance of the centerless ground glass outer barrel at the second end only.

### RELATED APPLICATIONS

U.S. patent application Ser. No. 10/368,204, filed Feb. 17, 2003, and U.S. patent application Ser. No. 10/717,810, filed Nov. 20, 2003.

### BACKGROUND OF THE INVENTION

(1) Field of the Invention

The present invention relates generally to systems and methods for area air monitoring systems and, more specifically, to centerless ground DAMMS or thermal desorption tubes.

(2) Description of the Prior Art

It is a common practice both in the military and industrial applications to continuously monitor the atmosphere to detect, warn, monitor and/or verify the history over long periods of time for the presence of toxic chemical agents and/or other chemical compounds of interest that may exist in the area being monitored. Various types of monitoring systems may utilize thermal desorption tubes, which are also referred to herein as DAAMS (depot area air monitoring system) tubes.

Centerless ground desorption tubes are utilized in some types of fittings where it is desirable that the centerless ground outer barrel fit exactly into the fitting to avoid leakage between the fitting and the outer barrel. For these applications, it is desirable to provide as perfectly round tube as possible which is produced by the process of centerless grinding which is performed utilizing highly specialized equipment. The external tolerance of centerless ground tubes is highly precise. These tolerances are usually less than plus or minus 0.001 inches and may more typically range between plus and minus 0.0001 to 0.000050 or even 0.000001 inches, referred to hereinafter as a centerless grinding tolerance.

In making centerless ground adsorbent tubes, it is desirable to provide a sturdy mounting for sorbent or adsorbent material without damaging the close tolerances produced by grinding. The industry accepted practice has been to utilize one or more frits within the centerless ground adsorbent material. The frit is comprised of glass grounds which typically are heated to thereby become affixed within the centerless ground tube. In some cases, the fire polishing to mount the frit within the centerless ground tube may cause slight changes to the tolerances at the position of the frit. However, this technique has been accepted as an industry standard that has been used for many years.

Fire polished fused glass spacers within the tubes to support the sorbent or adsorbent material at a selected position, which are used for other types of applications, have not been capable of being utilized with centerless ground adsorption tubes due the tolerance changes caused by fire polishing/fusing which are utilized to secure the glass spacers within the outer barrel of the adsorption tube. Thus, the slight change in tolerance due to fire polishing results in not being able to fit the tube exactly into the fitting thereby causing unacceptable leakage between the fitting and the tube.

More generally, thermal desorption tubes may be utilized for the detection of any chemical, biological, organism, or industrial warfare gas, matter, or agent. Thermal desorption tubes typically utilize solid sorbents or adsorbents packed typically within a glass tube. For some applications, stainless steel DAAMS tubes and glass-lined DAAMS tubes have been utilized in the past. The air in the depot or environment is drawn through the thermal desorption tube by a pump or blower over a predetermined time period whereby the sorbent or adsorbent adsorbs the sorbate or chemical of interest in the air which flows through the thermal desorption tubes. Thermal desorption tubes may be used to detect even very low levels of the desired element in the air that may be at such minute concentrations as to not be detectable by other means. The sample is then thermally desorbed into a gas chromatograph for separation and detection typically utilizing heating means, purge gases, filters, and the like. Use of the system is advantageous in that it allows the trapping and concentration of a large volume sample in a single sampling thermal desorption tube without the use of trapping solvents that would otherwise dilute the sample. After desorption, the thermal desorption tubes are reusable and ideally would generate virtually no waste.

Thermal desorption tubes have many applications and are often utilized for historical monitoring whereby the history of the air may be measured to provide a record of air history for a location going back for decades. In these cases, the thermal desorption tubes are removed at regular intervals by personnel and placed into suitable desorption equipment. On a daily basis, perhaps tens of thousands of thermal desorption tubes are removed, purged, measurements recorded, and then replaced.

While as mentioned above, DAAMS tubes are known to have been made of stainless steel and/or glass-lined stainless steel, this is not normally the case. High grade stainless steel, e.g. 316 stainless steel, stainless steel is an expensive material. Stainless steel and/or glass lined thermal desorption tubes are difficult to construct and expensive to operate. Moreover, even very high grade stainless steel tends to be significantly less chemically inert than glass, is electrically conductive, is subject to slight corrosion for many chemicals, especially over long time periods, and subject to other problems that may cause test contamination and/or problems.

Glass is much more commonly utilized for construction of the outer barrel of thermal desorption tubes. The glass may comprise, for instance, borosilicate glass or ground borosilicate glass. Adhesives are generally not used during construction because of the potential problem of sample contamination caused thereby. Thermal desorption tubes may utilize glass fusing to secure internal glass spacers that contain solid sorbent or adsorbent and any necessary screens, or the like.

Other than stainless steel, less fragile materials such as plastics, polymers, elastomerics, and the like, have much lower thermal degradation thresholds than glass or stainless steel so as to break down or thermally degrade when heated to the thermal desorption purging process temperatures that are typically and frequently utilized with glass construction thermal desorption tubes. In this case, such materials would then give off chemicals that could contaminate and thereby ruin or invalidate the sample.

The following U.S. Patents may be generally related to the above subject matter:

U.S. Pat. No. 5,397,410, issued Mar. 14, 1995, to R. A. Handly, discloses a method for making machine readable bar code markings on glassware and is incorporated herein by reference. A ceramic film first has bar code markings placed thereon. The ceramic film with the bar code markings is placed on the outer surface of the glassware. The ceramic film and glassware are heated or fired for a predetermined time period at a temperature over 1100 degrees Fahrenheit adequate to effect fusing of the film onto the glassware while providing a fused layer therebetween.

U.S. Publication No 2003/0067393 A1, published Apr. 10, 2003, to Albro et al., discloses a system for the collection of near real time confirmation samples is provided to quickly eliminate false positive alarms by confirming the presence or absence of a chemical agent when a monitor operating in near real time to detect the presence of that chemical agent generates an alarm. The confirmation sampling system is synchronized with the near real time monitor and the confirmation sampler and monitor draw common samples of the atmosphere of concern. In the event that the monitor generates an alarm, the confirmation sampler preserves the sample taken contemporaneously with the alarm event for separate analysis, and also takes and preserves one or more follow-on samples.

U.S. Pat. No. 5,922,443, issued Jul. 13, 1999, to Larsen et al., discloses a polymeric article and method for making a polymeric article, such as a catheter, are disclosed wherein the article is contacted with a swelling agent, such as a solvent, and a plasticizer to make the polymeric material softer and/or more pliable or flexible. The contacting may be carried our sequentially or simultaneously, using a solution containing a plasticizer and a solvent.

U.S. Pat. No. 4,885,500, issued Dec. 5, 1989, to Hansen et al., discloses A quartz quadrupole comprises a quartz substrate, conductive strips and low-conductivity strips. The substrate includes hyperbolic inner surfaces which provide the geometry for the conformed conductive strips to produce an appropriate electric field for mass filter operation. The use of quartz as a substrate material provides the thermal and electrical characteristics required by high performance mass filtering operations, including scanning mode operation to 800 amu and above. During such operation, potential field distortions by accumulated charge in cusp sections of the substrate are minimized by the low-conductivity strips, which are arranged to overlap longitudinal edges of the conductive strips. Formation of the quartz substrate is made possible by high precision machining, grinding and polishing of a refractory metal mandrel. The actual step of forming the substrate is simplified by the low thermal coefficient of expansion of the quartz. The conductive strips are applied by firing metal-glass frit tape. The low-conductivity strips are applied by firing a metal-oxide slurry including a bonding agent.

U.S. Pat. No. 4,021,219, issued May 3, 1977, to Stockdale et al., discloses A stacking method is employed to assemble a structure which includes a plurality of substantially identical, uniformly spaced parallel glass plates. The method includes the use of a fixture having a slotted surface in which rigid cylindrical spacers can be slidably disposed. Each glass plate is placed with its edge surface on the slotted surface and spaced from the adjacent plates by at least two of the cylindrical spacers, each of the spacers being disposed in a separate slot. Reference planes which are perpendicular to the surface of the fixture are provided so as to maintain the plates in the desired spatial relation. Then, a glass base is bonded onto the opposing edge surface of each of the spaced glass plates. The glass plates and glass base are preferably chosen to be of the same material. The spacers are chosen to be of a material having an expansion coefficient slightly greater than that of the glass plates and glass base.

The above patents do not provide a centerless thermal desorption tube without a frit. The inventor believes that a disadvantage of the use of the centerless ground tubes with a frit is that the ground glass frit and/or heating utilized to mount the frit therein produces a pressure drop which is not consistent from tube to tube. Therefore flow through the tube may be unpredictable or variable from tube to tube. This may cause inaccuracies in measurement. Accordingly, a centerless ground tube is provided as taught herein which provides a support for the sorbent or adsorbent material without the use of one or more frits. Those skilled in the art will appreciate the present invention that addresses the above and other problems.

### SUMMARY OF THE INVENTION

Accordingly, it is an objective of the present invention to provide an improved centerless ground DAAMS tube or adsorbent tube and method.

Another objective is to provide an almost perfectly round centerless ground glass adsorbent tube.

Another objective is to provide which is easily constructed with low cost materials.

Yet another object of the present invention is to provide a centerless ground DAAMS tube or adsorbent tube that does not utilize a frit.

Yet another object of the present invention is to provide a centerless DAAMS tube or adsorbent tube that provides more accurate readings.

These and other objectives, features, and advantages of the present invention will become apparent from the drawings, the descriptions given herein, and the appended claims. However, it will be understood that above listed objectives and advantages of the invention are intended only as an aid in understanding aspects of the invention, are not intended to limit the invention in any way, and do not form a comprehensive list of objectives, features, and advantages.

Accordingly, the present invention comprises a thermal desorption tube. One embodiment of a thermal desorption tube in accord with the present invention may comprise one or more elements such as, for example, an outer barrel and one or more inner spacers insertably positioned within the outer barrel. At least prior to an insertion of an inner spacer into the outer barrel, either the inner spacer or the outer barrel may comprise a bend or at least one bent portion. After insertion, friction is produced between the inner spacer and the outer barrel to secure the inner spacer with respect to the outer barrel. A sorbent material is positioned within the outer barrel. In one preferred embodiment, either or both of the outer barrel or the inner spacer(s) comprise a fluropolymer material, a non-limiting example being PTFE.

The thermal desorption tube may further comprise glass wool plugs positioned between at least two inner spacers with the sorbent material being positioned between the glass wool plugs. Additionally, the thermal desorption may further comprise at least two screens positioned outside the glass wool plugs but inside the spacers.

The outer barrel and the inner spacer(s) may be comprised of the same material or of different materials. In a preferred embodiment, at least one of the outer barrel or the spacer(s) may be comprised of a resilient material.

In another embodiment, the thermal desorption tube, may comprise one or more elements such as, for example, an outer barrel comprised of a non-glass and non-steel material a sorbent material positioned with the outer barrel. The material of the outer barrel may preferably be selected such that a maximum temperature required for a thermal desorption process of the sorbent material to which the outer barrel is to be heated during the thermal desorption process is less than a thermal degradation threshold of the material.

In yet another embodiment, the inner spacer(s) and the outer barrel may be sized so as to be held in position by friction after an insertion of spacer(s) within the outer barrel. At least prior to construction an inner diameter of the outer barrel may be slightly less than or equal to an outer diameter of the inner spacer(s) such that sufficient friction is produced by an interference fit therebetween to secure the inner spacer(s) within the outer barrel. Alternatively, the inner diameter may be slightly greater than the outer diameter of the inner spacer(s) and sufficiently close in tolerance, length, and so forth, to produce sufficient friction to hold the assembly together.

### BRIEF DESCRIPTION OF THE DRAWING

A more complete understanding of the invention and many of the attendant advantages thereto will be readily appreciated as the same becomes better understood by reference to the following detailed description when considered in conjunction with the accompanying drawing wherein corresponding reference characters indicate corresponding parts throughout the drawing and wherein:

FIG. 1 is an enlarged elevational view, in cross-section, of a centerless ground thermal desorption tube in accord with one embodiment of the present invention.

### DESCRIPTION OF THE PREFERRED EMBODIMENTS

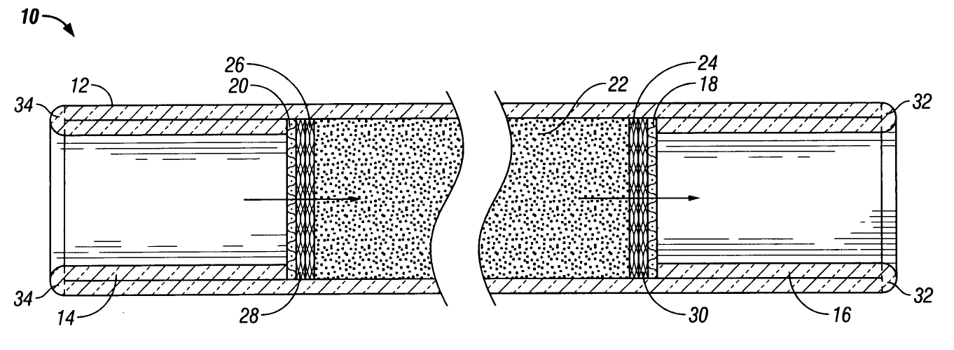

Referring now to the drawings and, more particularly, to FIG. 1 there is shown thermal desorption tube 10 in accord with the present invention.

As a general overview, thermal desorption tube 10 may comprise, in one possible embodiment, centerless ground outer barrel 12, one or more inner spacers such as inner spacers 14 and 16, one or more screens such as screens 18 and 20, inner glass wool plugs 24 and 26, outer glass wool plugs 28 and 30, and adsorbent or sorbent material 22. Various modifications of this basic construction may be utilized. For instance, multiple sorbent beds may be utilized which may be separated, if desired, by additional glass wool plugs and/or screens. Depending on the applications and types of adsorbent or sorbent material 22, stainless steel screens 18 and 20 may or may not be utilized and/or silanized glass wool plugs may or may not be utilized, as desired, for construction of thermal desorption tube 10.

In a preferred embodiment, centerless ground outer barrel 12 is comprised of borosilicate glass that has been centerless ground. Other centerless ground materials for outer barrel 12 include, but are not limited to: simax glass, Pyrex glass, quartz tubing fused quartz, synthetic silica. As used herein, these materials are referred to generally as glass. Centerless ground outer barrel 12 also could have manufacturing variations such as being extruded, dipped, coated, impressed, reinforced, wrapped, and/or sanitized. Centerless ground outer barrel 12 in accord with the present invention may be high purity labeled, have various wall thicknesses, may be tapered, colored, translucent, have raw ends, or may be fire polished at selected positions. Generally, use of other materials for outer barrel 12 are not desirable unless they are such that they can have a tolerance that is acceptable to provide a suitable seal when inserted into the fitting utilized by the customer.

Inner spacers 14 and 16 are preferably comprised of the same material as centerless ground outer barrel 12. In some cases, only one inner spacer may be used. If desired, the material of spacers 14 and/or 16 might be different from that of barrel 12 and might conceivably comprise non-glass materials as may be discussed in more detail in one or more of my previous application such as, for instance, related applications U.S. patent application Ser. No. 10/368,204, filed Feb. 17, 2003, and U.S. patent application Ser. No. 10/717,810, filed Nov. 20, 2003, all or which are incorporated herein by reference. Generally, while it is generally desirable to utilize the same materials, non-glass materials such as PTFE or the many non-glass materials listed in the above applications might possibly provide a fluid (gas) flow sealed friction fit, depending on the application, to avoid the need for fire polishing and/or any type of adhesives. Moreover, different material spacers may be used on either end of thermal desorption tube 10 depending on the possible usage therefore, although in a presently preferred embodiment if two spacers such as 14 and 16 are utilized, and/or other spacers, then the spacers would be comprised of the same material.

Generally, it is not necessary that inner spacers 14 and 16 are centerless ground, but one or more of the inner spacers could be centerless ground, if desired. For instance, centerless ground inner spacers might possibly be utilized to provide a fluid (gas) flow sealed friction fit with a glass outer barrel 12.

In one presently preferred embodiment, at least one inner spacer, such as inner spacer 14, is fire polished at end 32 before outer barrel 12 has been centerless ground. The fire polishing of end 32 firmly secures inner spacer 14 within outer barrel 12 and prevents any leakage between inner spacer 14 and outer barrel 12. After inner spacer 14 is fire polished so as to be secured within outer barrel 12, then outer barrel 12 is centerless ground, including at end 32, to provide a virtually perfectly round centerless ground outer barrel without the need for a frit to hold sorbent material 22 and/or the screens and/or glass wool in place within outer barrel 12. The perfectly round thermal desorption tube 10 will then provide a perfect mating surface to the fitting. Generally, only one inner spacer will be fire polished to secure it in place prior to having outer barrel 12 centerless ground. This is because one end of thermal desorption tube 10 may extend outwardly from the fitting and therefore it is not so important that the end not extending out of the fitting be perfectly round, such as due to fire polishing. Thus, the second inner spacer may be fire polished after outer barrel 12 is centerless ground. In some cases, a second inner spacer may not be utilized at all. As well, a different material spacer could be utilized with a friction fit as discussed above and in the related applications discussed hereinbefore.

However, it is also possible, after fire polishing the first inner spacer in position, and before the centerless grinding process, to completely construct the desired thermal desorption tube including any sorption material sections 22, screens, glass wool, and the like, and then fire polishing the second inner spacer. In this case, both inner spacers 14 and 16 may be fire polished prior to centerless grinding of outer barrel 12, at both ends 32 and 34. However, this method has the disadvantage that the sorbent material will be heated during the centerless grinding process. It is usually desirable that the sorbent material not be heated prior to sale to a customer. Nonetheless, the heating of the sorbent during the centerless grinding process may not be of importance to some customers.

While desorption tube 10 is shown as being straight, please note that desorption tube 10 may include bent sections or u-shaped sections if desired and depending on the types of fittings and/or other equipment with which desorption will be utilized.

As yet another option, if desired, the at least one of spacers 14 and/or 16 could be melted for securing spacers 14 and/or 16 in position within a centerless ground outer barrel 12 and/or special adhesives suitable for particular applications might be utilized and/or other mounting means may be utilized. If at least one of spacers 14 and/or 16 were comprised of non-glass material for friction fitting, such as PTFE, the wall thickness and length of spacers 14 and 16 will be factors that affect the friction produced by construction thereof in this manner. If PTFE or other non-glass materials are used for spacers 14 and/or 16, then spacers 14 and/or 16 might also be slightly tapered so as to be insertable to provide a somewhat compressed engagement to ensure a seal. The smallest diameter of the taper might then be less than an inner diameter of the outer barrel 12 but may increase to the slightly greater than the inner diameter of spacers 14 and 16 to permit insertion therein. The same tapering process might be utilized for friction sealing of glass spacers within outer barrel 12. Glass spacers are less compressible but may be designed to still tightly and sealingly fit together.

In another embodiment, depending on the materials utilized for barrel 12 and spacers 14 and/or 16, an interference fit may be utilized wherein the outer diameter of spacers 14 and 16 may be slightly greater than the inner diameter of barrel 12.

In a presently preferred embodiment, thermal desorption tube 10 may be easily constructed. For instance, spacer 16 may be inserted into outer barrel 12 and fire polished to secure spacer 16 in position. Generally, it is desirable that the end of spacer 16 be directly adjacent the end of outer barrel 12 as shown in FIG. 1. Conceivably, this arrangement could be varied.

Then outer barrel 12 with fire polished inner spacer 16 is centerless ground so as to be round to a great degree of precision. Screen 18 may be inserted, if desired. Then, if desired, glass wool plugs 28 and 30 may be inserted into outer barrel 12. Adsorbent or sorbent material 22 may be added. Glass wool plugs 26 and 28, and screen 20 may then be added. Then spacer 14 may be inserted and fire polished to secure it in position. Because spacers 14 and 16 are fixedly mounted with respect to barrel 12, spacers 14 and 16 easily hold the internal components in position. The fit is quite tight and sturdy. If end 32 is fire polished and then centerless ground, any suitable type of marking may be utilized to provide the customer with information as to which end is to be inserted into the fitting.

Barrel 12 is preferably of high purity and hardness. Sorbent or adsorbent material 22 may comprise but is not limited to: Tenax gr, Tenax ta, Chromasorb p, Chromosorb 100-108, Carbowax, Porapak, Hayesep A-Z, Carbosieve, Carboxen, Carbotrap, Silica gel, Charcoal, Acid washed glass beads, Carbopack, Molecular sieve, Anasorb GCB1, Anasorb GCB2, Carbosieve S-111, Anasorb CMS. If desired, and depending on the type of thereof, sorbent or adsorbent material 22 may be positioned within outer barrel 22 without use of screens or glass plugs and held in place by friction therewith. Other means to mount sorbent or adsorbent material 22 may be utilized. Sorbent or adsorbent material 22 may comprise fibrous polymer material. Sorbent or adsorbent material 22 may be formed in various shapes and constructions and may or may not comprise layers, substrates, woven portions, non-woven portions, tubular portions, powders, and the like.

One, two, or more screens such as screens 18 and/or 20, if utilized at all, may comprise materials such as the following but are not limited to: stainless steel, aluminum, brass, niobium, copper, gold, hastelloy, inconel, kanthanl, molybdenum, monel, mp35n, nichrome, nickel, bronze, platinum, silver, tantalum, titanium, tungsten, any diagonal, flat wire, hex or interchimp mesh, any market grade, raw edge, cut edge, or any selvage, any cloth thickness from 0.0005 to 0.9999, any twilled filter cloth weave, plain filter cloth weave, twilled weave, plain weave, unfc, micron weave, or other types of weaves.

One or more glass plugs such as plugs 24, 26, 28 and/or 30, if utilized at all, may comprise materials such as the following, but are not limited to: any borosilicated treated glass wool including Pyrex, simax, quartz, soda lime, kimax, synthetic silica, or Duran. The wool plugs product name may be Pyrex. Synonyms for this type of product include: angel hair, fiberglass, chemical name: borosilicate glass wool, silylated. The glass wool may be treated with a silylation reagent to react with the silanol groups to make it more suitable for its intended application in chromatography.

As shown in previous applications, a bar code (not shown) or other label which may be utilized to automate the recording process for recording the results, times, and other information related to use of thermal desorption tube 10. The bar code, if used, may also provide an indicator of which end of centerless ground outer barrel 12 to insert into the fitting.

Common sizes of barrel 12 may comprise but are not limited to an outside diameter of barrel 12 ranging from about ⅛ inches to about one inch. The minimum inside diameter of thermal desorption tube 10 may typically but not necessarily range from about 0.0390 inches to about one inch. The length of the adsorbent bed or beds may typically range from about 0.0390 inches to about seven inches. The length of barrel 12 may typically but not necessarily range from 0.0390 inches to about twenty-four inches. Spacers 14 and/or 16 may typically but not necessarily range in length from about 0.390 inches to about twelve inches.

Therefore, it will be understood that many additional changes in the details, materials, steps and arrangement of parts, which have been herein described and illustrated in order to explain the nature of the invention, may be made by those skilled in the art within the principle and scope of the invention as expressed in the appended claims.

1. A centerless ground thermal desorption tube for insertion into a fitting, said centerless ground desorption tube having an outer diameter with a centerless grinding tolerance sufficient to provide a seal with said fitting after insertion into said fitting, said centerless ground thermal desorption tube comprising:
a centerless ground tubular outer barrel which is centerless ground to said centerless grinding tolerance, said centerless ground tubular outer barrel having a first end and an opposing second end;
at least one tubular inner spacer mounted within said centerless ground outer barrel at said first end of said centerless ground outer barrel, said at least one tubular inner spacer being secured to said first end of said centerless ground outer barrel in a manner which does not alter said centerless grinding tolerance so that said first end of said centerless ground outer barrel is insertable into said fitting for providing said seal with said fitting; and
a sorbent material positioned within said centerless ground tubular outer barrel.

2. The centerless ground thermal desorption tube of claim 1 wherein said at least one tubular inner spacer comprises a glass material.

3. The centerless ground thermal desorption tube of claim 2 wherein said glass material of said at least one tubular spacer is heated so as to fuse with said first end of said centerless ground tubular outer barrel prior to a centerless grinding process of said centerless ground outer barrel such that said heating and fusing does not affect said centerless grinding tolerance.

4. The centerless ground thermal desorption tube of claim 3 further comprising a second inner spacer comprising glass material, said glass material of said second inner spacer is heated so as to fuse with said first end of said centerless ground tubular outer barrel after said centerless grinding process of said centerless ground outer barrel such that said heating and fusing does affect said centerless grinding tolerance.

5. The centerless ground thermal desorption tube of claim 1 wherein said centerless ground tubular outer barrel is comprised of glass.

6. The centerless ground thermal desorption tube of claim 1 wherein said centerless ground tubular outer barrel and said at least one tubular inner spacer are comprised of glass.

7. The centerless ground thermal desorption tube of claim 1 wherein an outer diameter of said at least one tubular inner spacer and an inner diameter of said centerless ground tubular outer barrel comprise tolerances close enough to provide a friction fit therebetween.

8. The centerless ground thermal desorption tube of claim 1 wherein said centerless ground tubular outer barrel is fire polished at least at one end with said at least one tubular inner spacer prior to a centerless grinding process so as to not change said centerless grinding tolerance.

9. The centerless ground thermal desorption tube of claim 1 further comprising at least one of a screen or a glass wool section.

10. The centerless ground thermal desorption tube of claim 1 wherein said at least one tubular inner spacer provides a support for said sorbent material.

11. A centerless ground thermal desorption tube, said centerless desorption tube having an outer diameter with a centerless grinding tolerance, said centerless ground thermal desorption tube comprising:
a centerless ground tubular outer barrel which is centerless ground to said centerless grinding tolerance, said centerless ground tubular outer barrel having a first end and an opposing second end;
at least one tubular inner spacer mounted within said centerless ground outer barrel at said first end of said centerless ground outer barrel, said at least one inner spacer being secured to said first end of said centerless ground outer barrel;
a sorbent material positioned within said centerless ground tubular outer barrel supported by said at least one inner spacer.

12. The centerless ground thermal desorption tube of claim 11 wherein said at least one inner spacer is fused to said centerless ground outer barrel by heating.

13. The centerless ground thermal desorption tube of claim 12 wherein said at least one inner spacer is fused to said centerless ground outer barrel before a centerless grinding process of said centerless ground outer barrel which creates said centerless grinding tolerance.

14. The centerless ground thermal desorption tube of claim 12 wherein said at least one inner spacer is fused to said centerless ground outer barrel after a centerless grinding process of said centerless ground outer barrel which creates said centerless grinding tolerance.

15. The centerless ground thermal desorption tube of 11, further comprising a first tubular inner spacer mounted within said centerless ground outer barrel at said first end of said centerless ground outer barrel and a second tubular inner spacer mounted within said centerless ground outer barrel at said second end of said centerless ground outer barrel.

16. A method for making a centerless ground desorption tube, comprising:
inserting a first inner tubular spacer into a first end of a tubular outer barrel;
mounting said first inner tubular spacer to a first end of said outer barrel so as to affix said first inner tubular spacer to said first end of said tubular outer barrel;
centerless grinding said combination of said first inner tubular space and said outer tubular outer barrel so that said tubular outer barrel is round within a centerless grinding tolerance;
inserting sorbent material into said tubular outer barrel through a second end of said tubular outer barrel which is opposite from said first end.

17. The method of claim 16 further comprising mounting said first inner tubular to said first end of said tubular outer barrel by heat fusing said first inner tubular spacer to said first end of said tubular outer barrel.

18. The method of claim 16, further comprising mounting a second inner tubular spacer to a second end of said tubular outer barrel after said step of centerless grinding of combination of said first inner tubular space and said outer tubular outer barrel.

19. The method of claim 18 further comprising mounting said second inner tubular to said second end of said tubular outer barrel by heat fusing said second inner tubular spacer to said second end of said tubular outer barrel.

20. The method of claim 16 further comprising inserting at least one of a screen or a section of glass wool material into said second end of said tubular outer barrel prior to or after inserting said sorbent material into said tubular outer barrel.
